(19) United States
(12) Patent Application Publication
(10) Pub. No.: US 2024/0388042 A1
(43) Pub. Date: Nov. 21, 2024

(54) Connector

(71) Applicant: Tyco Electronics (Shanghai) Co., Ltd., Shanghai (CN)

(72) Inventors: Hua (Andy) Li, Shanghai (CN); Wei Yao, Kunshan (CN)

(73) Assignee: Tyco Electronics (Shanghai) Co., Ltd., Shanghai (CN)

(21) Appl. No.: 18/666,006

(22) Filed: May 16, 2024

(30) Foreign Application Priority Data
May 18, 2023 (CN) 202310567235.8

(51) Int. Cl. H01R 13/6597; H01R 13/502; H01R 13/621; H01R 13/6598

(52) U.S. Cl. CPC H01R 13/6597; H01R 13/502; H01R 13/621; H01R 13/6598

(57) ABSTRACT

A connector includes an insulator, a terminal disposed in the insulator, and a ferrite core installed on the insulator. The ferrite core absorbs a plurality of interference signals to suppress an influence of the interference signals on the terminal.

### CROSS-REFERENCE TO RELATED APPLICATION

This application claims the benefit of the filing date under 35 U.S.C. § 119 (a)-(d) of Chinese Patent Application No. 202310567235.8, filed on May 18, 2023.

### FIELD OF THE INVENTION

The present invention relates to a connector, in particular to a connector that is resistant to electromagnetic interference.

### BACKGROUND

In order to prevent electromagnetic interference, it is usually necessary to install a metal electromagnetic shielding shell in the connector, and the terminals of the connector are set in the electromagnetic shielding shell. In this way, the terminals can be separated from external interference signals by the electromagnetic shielding shell to prevent adverse effects of external interference signals on the terminals. However, the anti-interference performance of the electromagnetic shielding shell is poor because they cannot be completely enclosed, with openings and gaps, which can lead to electromagnetic leakage. Moreover, the complex structure of the electromagnetic shielding shell makes its installation and manufacturing very difficult, which increases the cost of the connector.

### SUMMARY

A connector includes an insulator, a terminal disposed in the insulator, and a ferrite core installed on the insulator. The ferrite core absorbs a plurality of interference signals to suppress an influence of the interference signals on the terminal.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of a connector according to an exemplary embodiment of the present invention;

FIG. 3 shows an illustrative exploded view of a connector according to an exemplary embodiment of the present invention, viewed from the rear end, wherein the housing is not shown;

FIG. 4 shows an illustrative exploded view of a connector according to an exemplary embodiment of the present invention, viewed from the bottom, wherein the housing is not shown;

FIG. 5 shows an illustrative perspective view of a connector according to an exemplary embodiment of the present invention, viewed from the bottom, wherein the housing is not shown;

FIG. 6 shows an illustrative perspective view of a connector according to an exemplary embodiment of the present invention, viewed from the rear end, wherein the housing is not shown;

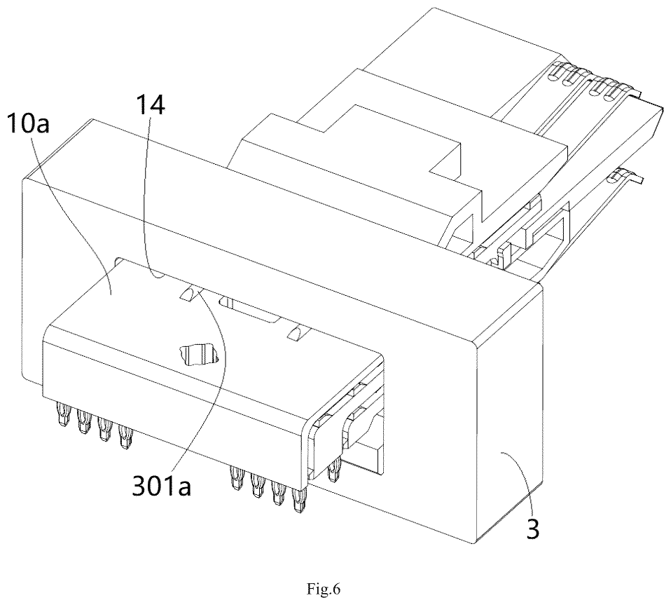

FIG. 7 shows a longitudinal sectional view of a connector according to an exemplary embodiment of the present invention, wherein the housing is not shown; and

FIG. 8 shows an illustrative exploded view of the insulation and terminals of a connector according to an exemplary embodiment of the present invention.

### DETAILED DESCRIPTION OF EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

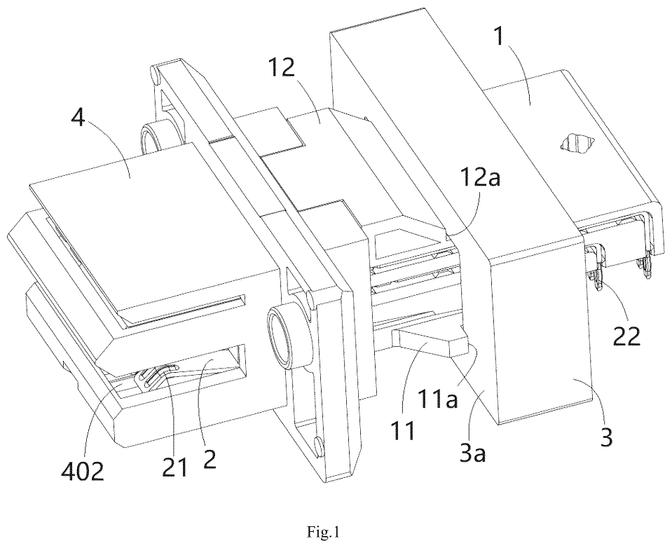

As shown in FIGS. 1 to 4, in an exemplary embodiment of the present invention, a connector is disclosed. The connector includes an insulator 1, a terminal 2, and a ferrite core 3. The terminal 2 is provided in the insulator 1. The ferrite core 3 is installed on the insulator 1. The insulator 1 is used to maintain the terminal 2 and electrically isolate the terminal 2 from the ferrite core 3. The ferrite core 3 is used to absorb interference signals to suppress the impact of interference signals on the terminal 2, thereby improving the signal transmission quality of the connector.

In an exemplary embodiment of the present invention, the ferrite core 3 may include a manganese zinc ferrite core for suppressing low-frequency interference signals and/or a nickel zinc ferrite core for suppressing high-frequency interference signals.

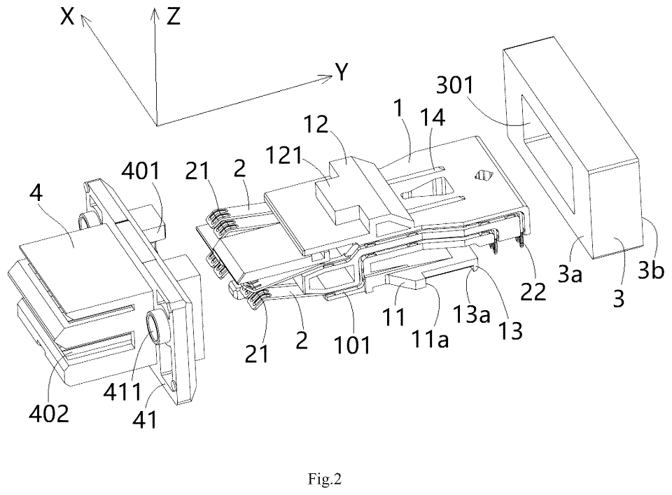

As shown in FIGS. 2 to 4, in an exemplary embodiment of the present invention, an installation hole 301 is formed in the ferrite core 3, and the insulator 1 and terminal 2 pass through the installation hole 301 of the ferrite core 3. In the illustrated embodiment, the ferrite core 3 is formed into a rectangular frame. However, the shape of ferrite core 3 is not limited to the illustrated embodiments, and it can also have other suitable shapes, such as a hollow cylindrical body.

In the illustrated embodiments, the ferrite core 3 is an integral piece, and the ferrite core 3 is mounted on the insulator 1. The structure of the ferrite core 3 of the present invention is not limited to the illustrated embodiments, for example, the ferrite core 3 can also be a split structure. For example, the ferrite core 3 may include two or more separate components assembled onto the insulator 1. This can make the installation operation of ferrite core 3 easier.

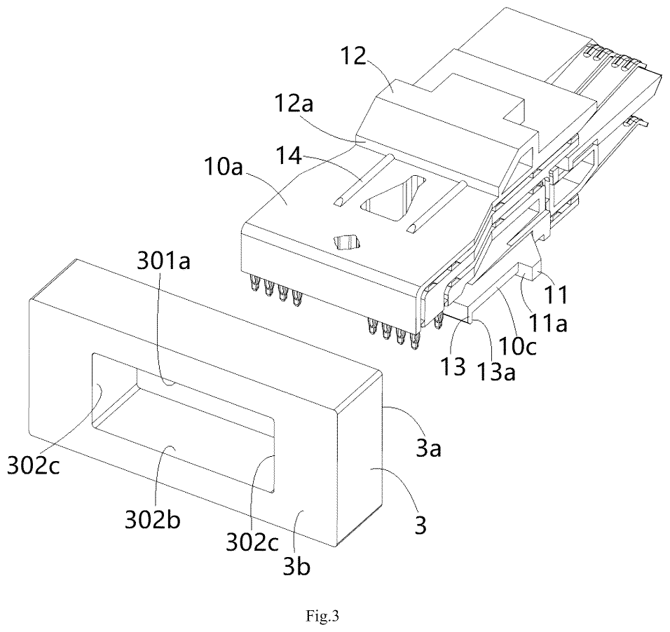

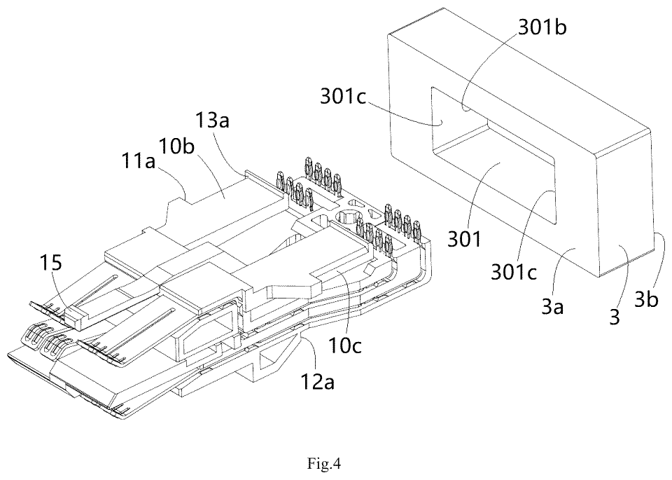

As shown in FIGS. 3 and 4, in the illustrated embodiments, the insulator 1 has opposite top surfaces 10a and bottom surfaces 10b in its height direction Z, and convex ribs 14 are formed on the top surface 10a and/or bottom surface 10b of the insulator 1. The convex rib 14 extends along the longitudinal direction Y of the insulator 1 and is used for interference fit with the hole wall of the installation hole 301 of the ferrite core 3, in order to fix the ferrite core 3 to the insulator 1.

In the illustrated embodiments, as shown in FIGS. 2 and 3, multiple convex ribs 14 are formed on the top surface 10a of the insulator 1, and no convex rib 14 is formed on the bottom surface 10b of the insulator 1. The convex ribs 14 on the top surface 10a of the insulator 1 are in interference fit with the upper wall surface 301a inside the installation hole 301, and the bottom surface 10b of the insulator 1 is against the lower wall surface 301b inside the installation hole 301. However, the present invention is not limited to the illustrated embodiments, for example, multiple convex ribs 14 can be formed on each of the top surface 10a and the bottom surface 10b of the insulator 1.

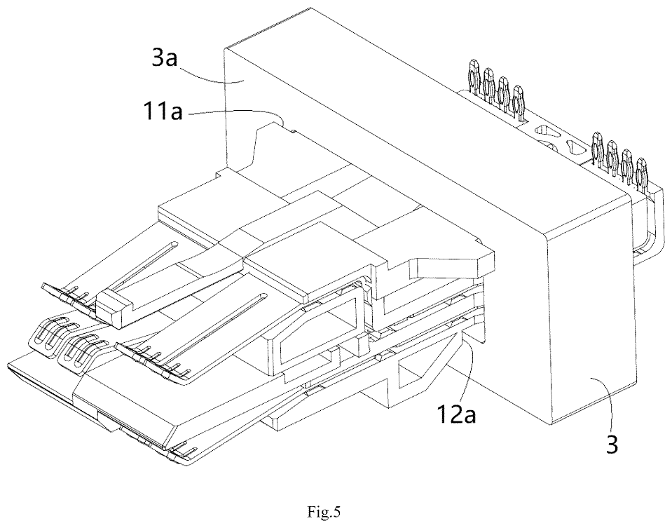

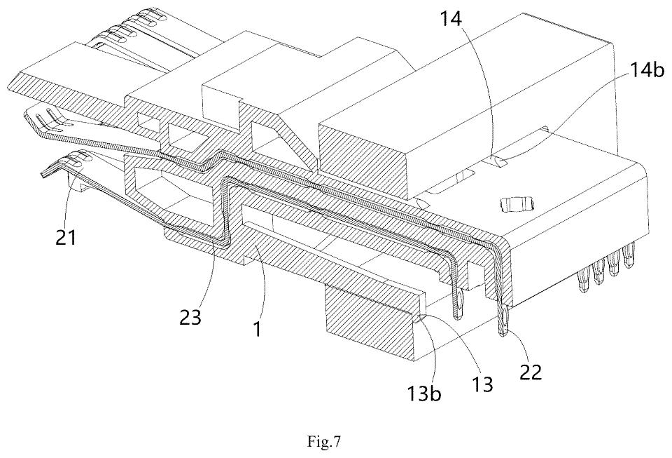

As shown in FIGS. 2 to 4, in the illustrated embodiments, the ferrite core 3 has a front surface 3a and a rear surface 3b opposite to each other in the longitudinal direction Y of the insulator 1. A first positioning protrusion 11 is formed on the insulator 1, and the first positioning protrusion 11 is against the front surface 3a of the ferrite core 3, as shown in FIG. 5. An elastic buckle 13 is also formed on the insulator 1, the elastic buckle 13 is against the rear surface 3b of ferrite core 3, as shown in FIG. 7. In this way, the ferrite core 3 cannot be moved in the longitudinal direction Y of the insulator 1.

As shown in FIG. 7, in the illustrated embodiments, a first inclined guide surface 14b is formed on the rear end of the convex rib 14 to guide the convex rib 14 into the installation hole 301 of the ferrite core 3. A second inclined guide surface 13b is formed on the clastic buckle 13 to guide the elastic buckle 13 into the installation hole 301 of the ferrite core 3. In this way, it is easy to fit the ferrite core 3 from the rear end of the insulator 1 onto the insulator 1.

As shown in FIGS. 2, 3, and 5, in the illustrated embodiments, the first positioning protrusion 11 has a first front positioning surface 11a, which abuts against the front surface 3a of the ferrite core 3. The elastic buckle 13 has a rear positioning surface 13a, shown in FIG. 4, which is against the rear surface 3b of the ferrite core 3. The first front positioning surface 11a, the front surface 3a, the rear positioning surface 13a, and the rear surface 3b are perpendicular to the longitudinal direction Y of the insulator 1.

As shown in FIG. 2, in the illustrated embodiments, the insulator 1 has opposite left and right sides in its transverse direction X. The insulator 1 has a pair of first positioning protrusions 11, which are respectively located on the left and right sides of the insulator 1 and near the bottom of the insulator 1. The insulator 1 has a pair of clastic buckles 13, which are located on the bottom surface 10b of the insulator 1 and are respectively close to the left and right sides of the insulator 1.

As shown in FIG. 2, in the illustrated embodiments, a second positioning protrusion 12 is formed on the top surface 10a of the insulator 1, and the second positioning protrusion 12 has a second front positioning surface 12a, shown in FIG. 1, which is against the front surface 3a of the ferrite core 3. The second front positioning plane 12a is perpendicular to the longitudinal direction Y of the insulator 1 and extends from the left side to the right side of the insulator 1 along the transverse direction X of the insulator 1.

As shown in FIGS. 3 and 4, in the illustrated embodiments, the insulator 1 has a pair of side positioning surfaces 10c located on its left and right sides respectively, and the pair of side positioning surfaces 10c are against the left and right opposite side wall surfaces 301c in the installation hole 301, as shown in FIG. 5. The side positioning surface 10c of the second positioning protrusion 12 is perpendicular to the transverse direction X of the insulator 1 and intersects vertically with the first front positioning surface 11a.

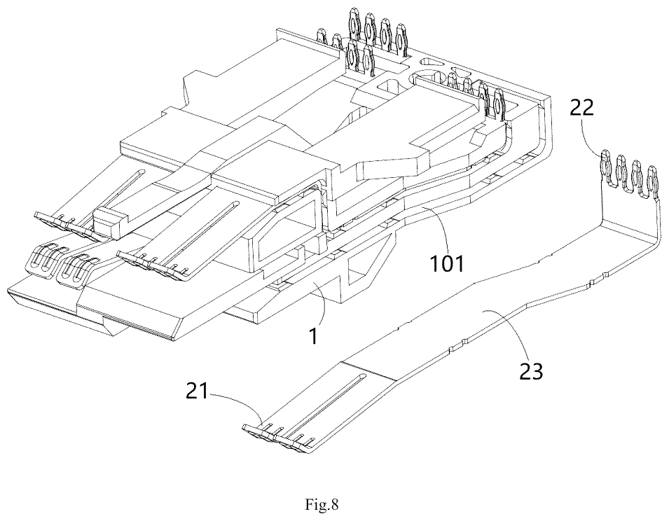

As shown in FIG. 2, in the illustrated embodiments, the terminal 2 includes a contact end 21, a connection end 22, and a connecting part 23, shown in FIGS. 7 and 8. The contact end 21 is exposed from the front end of the insulator 1 and is used for electrical contact with a mating terminal of a mating connector. The connection end 22 extends from the bottom of the rear end of the insulator 1 and is used to be inserted into a hole formed in a circuit board for electrical connection with the circuit board. The connecting part 23 is connected between the contact end 21 and the connection end 22 and is fixed in the insulator 1. In the shown embodiment, a terminal installation slot 101 is formed on the insulator 1, as shown in FIG. 8, and at least a portion of the connection part 23 of the terminal 2 is fixed in the terminal installation slot 101.

In the illustrated embodiments, the insulator 1 and the terminal 2 are two independent components formed separately, and the terminal 2 is inserted into the terminal installation slot 101 of the insulator 1. However, the present invention is not limited to the illustrated embodiments. For example, in another exemplary embodiment of the present invention, the insulator 1 can be an injection molded part directly formed onto the terminal 2, so that the insulator 1 and the terminal 2 are formed into an integral piece.

As shown in FIGS. 1 and 2, in the illustrated embodiments, the connector further comprises a housing 4. The front end of the insulator 1 is inserted into housing 4. A slot 402 is formed on the housing 4 that allows for the insertion of the mating terminal. The contact end 21 of terminal 2 extends into the slot 402 for electrical contact with the mating terminal inserted into the slot 402.

As shown in FIG. 2, in the illustrated embodiments, a positioning tongue 121 is formed on the insulator 1, which is connected to the aforementioned second positioning protrusion 12 and extends forward from the second positioning protrusion 12. A positioning recess 401 is formed on the rear end of the housing 4, which is matched with the positioning tongue 121, to position the insulator 1 onto the housing 4.

As shown in FIG. 4, in the illustrated embodiments, an elastic locking buckle 15 is formed on the insulator 1, which is inserted into the housing 4 and engages with a mating locking buckle feature (such as a concave or stepped part) inside the housing 4 to lock the insulator 1 to the housing 4.

As shown in FIG. 2, in the illustrated embodiments, the housing 4 has a flange portion 41 for installation on an installation panel, and a connection hole 411 is formed in the flange portion 41 that allows a connecting member (such as a screw or bolt) to pass through, so that the housing 4 can be fixed to the installation panel through the connecting member.

In another exemplary embodiment of the present invention, a connector is also disclosed. The connector mainly includes a terminal 2 and a ferrite core 3.

The ferrite core 3 is used to absorb interference signals and suppress the influence of interference signals on the terminal 2. The ferrite core 3 improves the electromagnetic interference resistance performance of the connector. Moreover, the structure of ferrite core 3 is simple, making manufacturing and installation very easy, greatly reducing the manufacturing cost of connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
an insulator;
a terminal disposed in the insulator; and
a ferrite core installed on the insulator, the ferrite core absorbs a plurality of interference signals to suppress an influence of the interference signals on the terminal.

2. The connector of claim 1, wherein the ferrite core has a manganese zinc ferrite core for suppressing a plurality of low-frequency interference signals and/or a nickel zinc ferrite core for suppressing a plurality of high-frequency interference signals.

3. The connector of claim 1, wherein an installation hole is formed in the ferrite core, the insulator and the terminal pass through the installation hole of the ferrite core.

4. The connector of claim 3, wherein the ferrite core is an integral piece and is sheathed on the insulator.

5. The connector of claim 3, wherein the ferrite core has a plurality of components assembled onto the insulator.

6. The connector of claim 3, wherein the insulator has a top surface and a bottom surface opposite the top surface in a height direction, a plurality of convex ribs are formed on the top surface and/or the bottom surface of the insulator, the convex ribs extend along a longitudinal direction of the insulator and are interference fit with a hole wall of the installation hole.

7. The connector of claim 6, wherein the convex ribs are formed on the top surface of the insulator and not on the bottom surface of the insulator, the convex ribs on the top surface of the insulator are interference fit with an upper wall surface inside the installation hole and the bottom surface of the insulator is against a lower wall surface inside the installation hole.

8. The connector of claim 3, wherein the ferrite core has a front surface and a rear surface opposite to the front surface in a longitudinal direction of the insulator, a first positioning protrusion is formed on the insulator and is against the front surface of the ferrite core, the insulator has an elastic buckle against the rear surface of the ferrite core.

9. The connector of claim 6, wherein each of the convex ribs has a first inclined guide surface on a rear end of the convex rib to guide the convex rib into the installation hole.

10. The connector of claim 8, wherein the elastic buckle has a second inclined guide surface guiding the elastic buckle into the installation hole.

11. The connector of claim 8, wherein the first positioning protrusion has a first front positioning surface against the front surface of the ferrite core, the elastic buckle has a rear positioning surface against the rear surface of the ferrite core, the first front positioning surface, the front surface of the ferrite core, the rear positioning surface, and the rear surface of the ferrite core are perpendicular to the longitudinal direction of the insulator.

12. The connector of claim 11, wherein the insulator has a left side and a right side opposite the left side in a transverse direction, the insulator has a pair of first positioning protrusions respectively positioned on the left side and the right side of the insulator adjacent to a bottom of the insulator, the elastic buckle is one of a pair of elastic buckles on a bottom surface of the insulator that are adjacent to the left side and the right side of the insulator.

13. The connector of claim 12, wherein the insulator has a second positioning protrusion on a top surface of the insulator, the second positioning protrusion has a second front positioning surface against the front surface of the ferrite core, the second front positioning surface is perpendicular to the longitudinal direction and extends from the left side to the right side of the insulator along the transverse direction.

14. The connector of claim 12, wherein the insulator has a pair of side positioning surfaces respectively located on the left side and the right side of the insulator, the side positioning surfaces are against a left side wall surface and a right side wall surface of the installation hole, the side positioning surfaces are perpendicular to the transverse direction and intersect vertically with the first front positioning surface.

15. The connector of claim 1, wherein the terminal includes:
a contact end exposed from a front end of the insulator for electrical contact with a mating terminal of a mating connector;
a connection end extending from a bottom surface of a rear end of the insulator for insertion into a hole formed in a circuit board; and
a connecting part connected between the contact end and the connection end and fixed in the insulator, a terminal installation slot is formed on the insulator, at least a portion of the connecting part of the terminal is fixed in the terminal installation slot.

16. The connector of claim 1, wherein the insulator is an injection molded part directly formed onto the terminal, the insulator and the terminal are an integral part.

17. The connector of claim 15, further comprising a housing in which the front end of the insulator is inserted, the housing has a slot receiving the mating terminal, the contact end of the terminal extends into the slot for electrical contact with the mating terminal inserted into the slot.

18. The connector of claim 17, wherein the insulator has a positioning tongue, a rear end of the housing has a positioning recess corresponding with the positioning tongue to position the insulator with respect to the housing, the insulator has an elastic locking buckle inserted into the housing and engaged with a mating locking buckle feature inside the housing to lock the insulator to the housing.

19. The connector of claim 17, wherein the housing has a flange portion for installation on a mounting panel, a connecting hole is formed in the flange portion that allows a connecting member to pass through to fix the housing to the mounting panel.

20. A connector, comprising:
a terminal; and
a ferrite core absorbing a plurality of interference signals to suppress an influence of the interference signals on the terminal.
